(19) United States
(12) Patent Application Publication
(10) Pub. No.: US 2007/0114858 A1
(43) Pub. Date: May 24, 2007

(54) Rotor for use in motor with cooling function

(75) Inventors: Seung Yeol Lee, Seoul (KR); Jin-Cheol Park, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS CORPORATION, Seoul (KR)

(21) Appl. No.: 11/603,001

(22) Filed: Nov. 22, 2006

(30) Foreign Application Priority Data
Nov. 23, 2005 (KR) 10-2005-0112288
Nov. 23, 2005 (KR) 10-2005-0112293

(51) Int. Cl. H02K 9/06; H02K 9/00

(52) U.S. Cl. 310/62; 310/63

(57) ABSTRACT

A rotor for use in a motor with a cooling function includes a main body and a plurality of cooling blades formed to be integrated with the main body. The main body includes attachment reinforcing openings and is formed by pressing soft magnetic powder. The cooling blades are formed through injection molding into the respective attachment reinforcing openings of the main body. Alternatively, the cooling blades are integrally formed with the main body by pressing along with the main body.

### FIELD OF THE INVENTION

The present invention relates to a rotor for use in a motor with a cooling function, and more particularly, to a rotor for use in a motor with a cooling function, wherein cooling blades of the rotor are formed through injection molding so as to achieve a simplified assembly process and improved durability of the rotor.

### BACKGROUND OF THE INVENTION

In general, a motor is a device that converts electrical energy into mechanical energy to provide a rotational force. Motors are being widely applied to various industrial fields including electric home appliances and industrial machines. Motors can be largely divided into alternating current (AC) motors and direct current (DC) motors.

With reference to FIG. 1, a conventional motor will be descried hereinafter.

FIG. 1 illustrates a sectional view of a conventional motor 10, particularly, an induction motor, which is one of AC motors. The conventional motor 10 includes a stator 11, a rotor 12, a shaft 13, and cooling fans 15. The stator 11 is affixed to a casing 14, and the rotor 12 is installed to be rotatable by having a gap inside the stator 11. The shaft 13 is pressed into a central part of the rotor 12 and rotates together with the rotor 12. The cooling fans 15 are installed on both edge regions of the rotor 12.

The stator 11 includes a coil 11a and a stator coil 11b of a magnetic substance. The coil 11a is supplied with AC current to generate a rotating magnetic field. The stator coil 11b generates flow paths of magnetic fluxes produced by the rotating magnetic field of the coil 11a.

The stator coil 11b is formed by stacking a plurality of identically shaped silicon steel sheets over each other in an axial direction. Although not illustrated, a plurality of slots is radially spaced a certain distance apart from each other along the inner surface of the stator coil 11b. The coil 11a is coiled around the slots using a distributional coiling method, a central coiling method, or a concentric coiling method.

The rotor 12 includes conductors (not shown) and a rotor core 12b of the magnetic substance. The conductors generate a torque by reciprocal reactions between the current provided by the coil 11a and the magnetic fluxes. The rotor core 12b has the conductors (not shown) installed therein and provides flow paths of the magnetic fluxes.

The conductors are formed of a metal such as aluminum or copper having high electrical conductivity, or magnets.

The rotor core 12b is formed by stacking a plurality of identically shaped silicon steel sheets in an axial direction. Although not illustrated, a plurality of slots is radially spaced a certain distance apart from each other in parallel to the axial direction on the outer surface or the inner side of the rotor core 12b. As like the coil 11a, the conductors of the rotor 12 are installed around the slots to run parallel to the axial direction.

The shaft 13 passes through the rotor core 12b to be affixed to the rotor 12 so as to rotate by means of holders 14a and bearings 14b disposed on both sides of the casing 14.

The cooling fans 15 are formed through injection molding to be attached or affixed to the edge regions of the rotor 12. Particularly, the cooling fans 15 are formed in a certain shape to produce a wind when rotating.

The conventional motor 10 operates as in the following.

When AC current is supplied to the coil 11a, a magnetic field is generated in a vertical direction to the axis. As a result, the magnetic fluxes start rotating through the stator coil 11b, and the rotating magnetic fluxes cross the conductors of the rotor 12 through the gap to thereby provide a certain amount of current to the conductors. The current provided to the conductors generates a torque in the rotor 12 according to the Fleming's left hand rule.

When the rotor 12 rotates, the cooling fans 15 also rotate to move air in from the outside and discharge the air to the inside of the casing 14 for air circulation. As a result, the motor 10 is cooled down.

However, in the conventional motor 10, since the rotor core 12b is formed by stacking the multiple silicon steel sheets having the same shape over each other, a structure for attaching the cooling fans 15 to the rotor 12 may be formed with some limitations. Thus, it is often required to form the cooling fans 15 in such a structure to be attached to the rotor core 12b. Due to this structural burden, there may be a complication in implementing a desired structure and difficulties in miniaturization and a firm attachment of the cooling fans 15 to the rotor core 12b. For instance, one of such motors is disclosed in U.S. Pat. No. 6,006,553, entitled “HEAT DISSIPATING BLADES FOR A MOTOR OF A WASHING MACHINE”.

Also, an assembly process is generally performed to attach the cooling fans 15 to the rotor core 12b, and thus, the manufacturing process may become complex, resulting in decrease in productivity.

### SUMMARY OF THE INVENTION

It is, therefore, an object of the present invention to provide a rotor for use in a motor with a cooling function, wherein cooling blades of the rotor are formed be integrated with the rotor so as to reduce a cost for manufacturing cooling fans, aid miniaturization of products and improve productivity through simplifying an assembly process.

In accordance with a preferred embodiment of the present invention, there is provided a rotor for use in a motor with a cooling function, the rotor including a main body formed by pressing soft magnetic powder, and a plurality of cooling blades formed to be integrated with the main body to produce a wind for cooling when the rotor rotates.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a sectional view of a conventional motor;

FIG. 2 illustrates a sectional view of a motor in accordance with a first embodiment of the present invention;

FIG. 3 illustrates a perspective view of a main body of a rotor for use in motor with a cooling function in accordance with the first embodiment of the present invention;

FIG. 4 illustrates a perspective view of the rotor for use in the motor with the cooling function in accordance with the first embodiment of the present invention;

FIG. 5 illustrates a sectional view of a motor in accordance with a second embodiment of the present invention;

FIG. 6 illustrates a perspective view of a main body of a rotor for use in the motor with a cooling function in accordance with a second embodiment of the present invention;

FIG. 7 illustrates a perspective view of the rotor for use in the motor with the cooling function in accordance with the second embodiment of the present invention;

FIG. 8 illustrates a sectional view of a motor in accordance with a third embodiment of the present invention;

FIGS. 9 and 10 illustrate top views of various types of rotors having a cooling function in accordance with the third embodiment of the present invention;

FIG. 11 illustrates a sectional view of a motor in accordance with a fourth embodiment of the present invention; and

FIG. 12 illustrates a top view of a rotor for use in the motor with a cooling function in accordance with the fourth embodiment of the present invention.

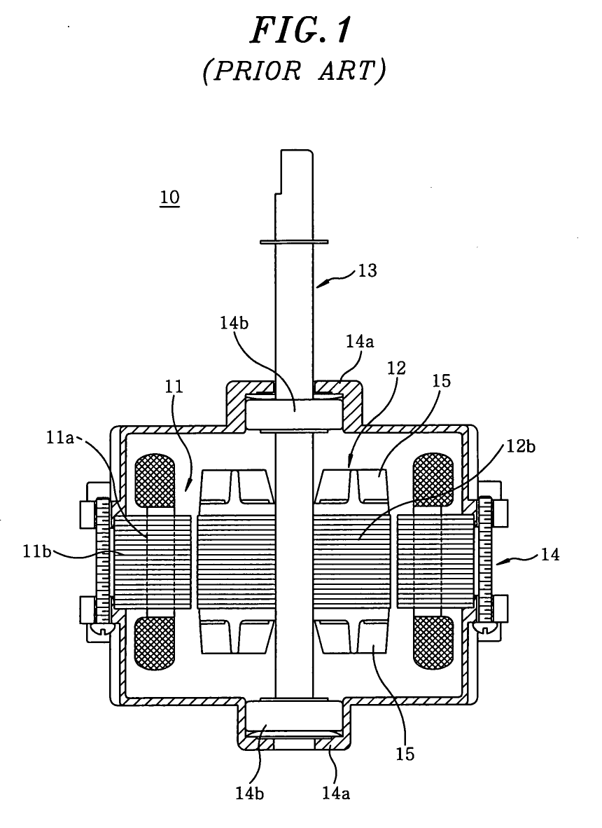

### DETAILED DESCRIPTION OF THE PREFERRED EMBODIMENTS

Hereinafter, preferred embodiments of the present invention will be described in detail with reference to the accompanying drawings.

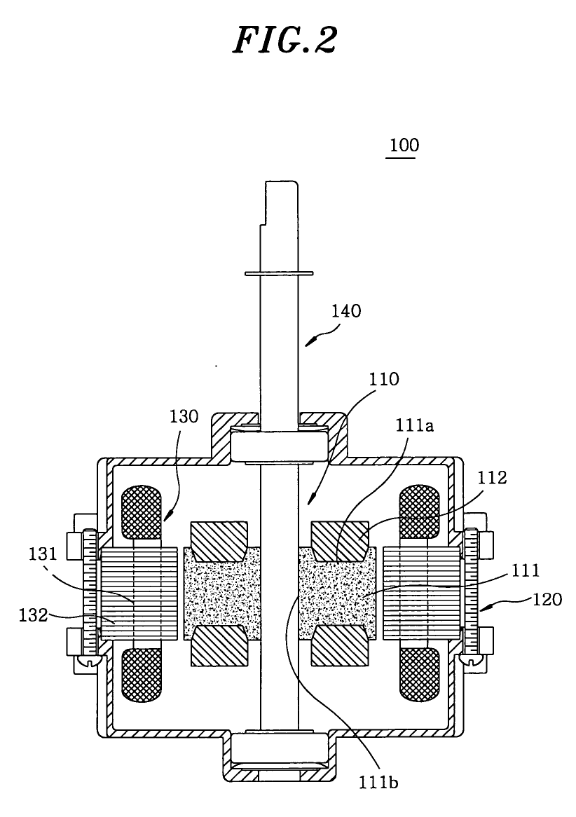

Referring now to FIG. 2, there is illustrated a sectional view of a motor 100 in accordance with a first embodiment of the present invention.

The motor 100 includes a rotor 110 having a cooling function. The rotor 110 includes a main body 111 and cooling blades 112, and is molded by pressing soft magnetic powder. The main body ill is installed to be rotatable by having a gap inside a stator 130 affixed to a casing 120 and provides flow paths of magnetic fluxes. The main body 111 includes attachment reinforcing openings 111a on outer surface portions of the main body 110. Each of the cooling blades 112 are formed to protrude through injection molding of the cooling blades 112 into the respective attachment reinforcing openings 111a.

In the first embodiment of the present invention, the rotor 110 includes the cooling blades 112 on both upper and lower sides of the main body 111. However, the cooling blades 112 may also be placed on one of the upper and lower sides.

A shaft cavity 111b is formed in a central region of the main body 111 to firmly hold a shaft 140, and the attachment reinforcing openings 111a are formed on the upper and lower surfaces of the main body 110 for the injection molding of the cooling blades 112.

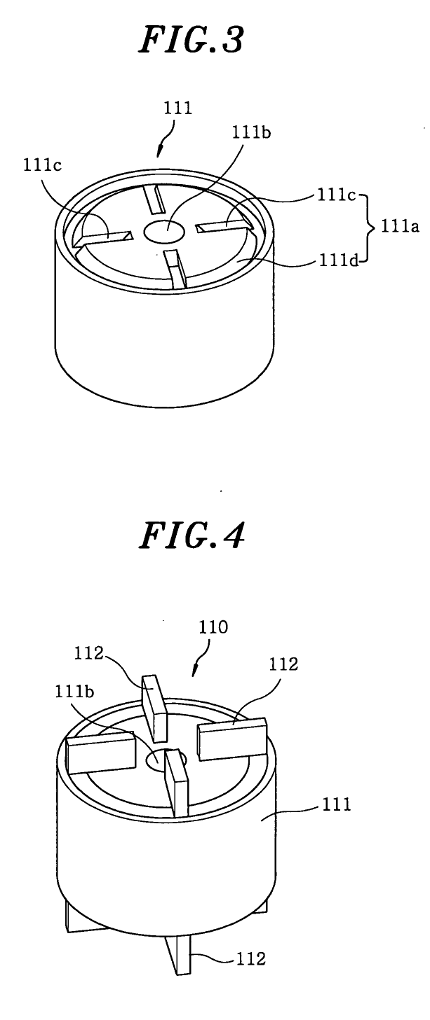

In case where the multiple cooling blades 112 exist, as illustrated in FIG. 3, the attachment reinforcing openings 111a are formed in one integral opening by including first openings 111c and second openings 111d. The first openings 111c, as shown, are formed on those points where the respective cooling blades 112 are placed, and the second openings 111d connect the first openings 111c individually with each other. Alternatively, the attachment reinforcing openings 111a may be formed in multiple numbers of the openings corresponding to the respective cooling blades 112. In addition to these mentioned structures, the attachment reinforcing openings 111a can be formed in various structures.

The attachment reinforcing openings 111a allow the cooling blades 112 to be firmly affixed to the main body 111 by increasing the attachment surface of the attachment reinforcing openings 111a with a material to be molded by injection and a bonding force to the cooling blades 112 obtained after the injection molding.

The cooling blades 112 are injected into the respective attachment reinforcing openings 111a to protrude so as to generate a wind for cooling when the main body 111 rotates.

As illustrated in FIG. 4, the cooling blades 112 are formed in a half-diameter direction, i.e., toward the outer side from the shaft cavity 111b, which is the center of the rotation, and arranged around the center of the rotation. As illustrated, the multiple cooling blades 112 exist.

As illustrated in the first embodiment of the present invention, the cooling blades 112 may be formed such that the cooling blades 112 are formed in the shape of a straight line when viewed from the top. Alternatively, the cooling blades 112 may be formed in a curvature shape from the top view.

As described above, the main body 111 is formed by pressing the soft magnetic powder, and thus, forming the attachment reinforcing openings 111a into which the cooling blades 112 are injected and molded. The soft magnetic power includes iron-based particles, each coated with a certain material to be electrically insulated from each other.

For the press molding of the main body 111, a molding space having substantially the same shape as the main body 111 is prepared in a press molding machine, and then filled with the soft magnetic powder. Then, a press member such as a punch is used to press the soft magnetic powder to form the attachment reinforcing openings 111a in the main body 111. At this time, a lubricating agent and/or a binding agent may be added to the soft magnetic powder and pressed together.

The main body 111 includes a three-dimensional soft magnetic composite (SMC) due to the aforementioned press process on the soft magnetic powder. As compared with the conventional process of using the silicon steel sheets, the main body 111 is allowed to have an increased degree of freedom. Thus, different from the conventional stack structure of the silicon steel sheets having the same shape, this SMC allows the formation of the attachment reinforcing openings 111a in various shapes.

The main body 111 is installed into an injection molding machine to form the cooling blades 112 on the respective attachment reinforcing openings 111a. Also, an injection molding material such as synthetic resin is injected into a molder having a space for forming the cooling blades 112, and molded to form the cooling blades 112 integrated with the main body 111.

Although the implementation of the rotor 110 in the motor 100, more particularly, the induction motor 100, is exemplified in the first embodiment, the rotor 110 can also be implemented in other types of motors such as AC motors and DC motors, which usually require the cooling. In the first embodiment of the present invention, as the rotor 110 is implemented in the induction motor 100, although not illustrated, conductors for providing a certain amount of current to a target are placed around slots formed on the outer surface or the inner side of the main body 111.

The rotor 110 having the cooling function in accordance with the first embodiment of the present invention operates as follows.

When AC current is supplied to a coil 131 of the stator 130, rotating magnetic fluxes are produced through a stator core 132. This rotating magnetic fluxes cross the conductors (not shown) of the rotor 110, placed on the outer surface or the inner side of the main body 111, through the gap to provide a certain amount of current to the conductors (not shown), so that the rotor 110 produces a torque.

Due to the torque, the rotor 110 rotates, and the cooling blades 112 rotating along with the main body 111 to produce a wind, which causes air to be moved in from the outside of the casing 120 and discharged to the inside thereof. As a result, the inner side of the casing 120 is cooled down.

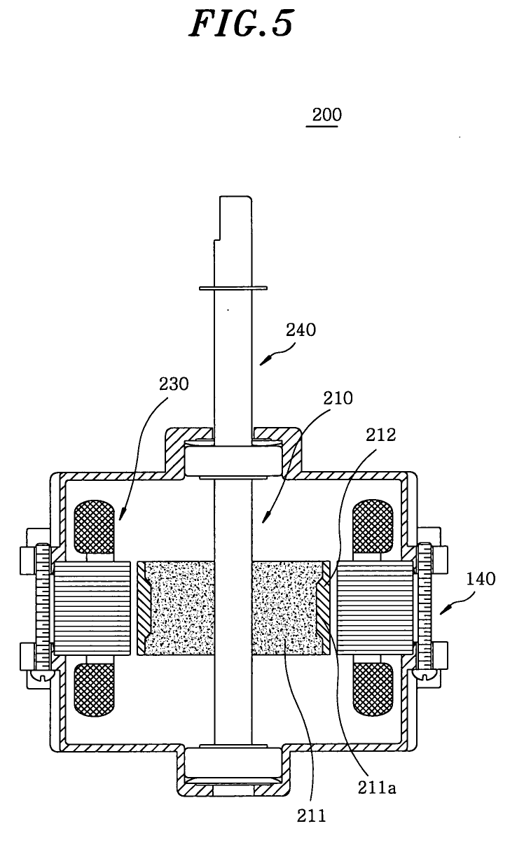

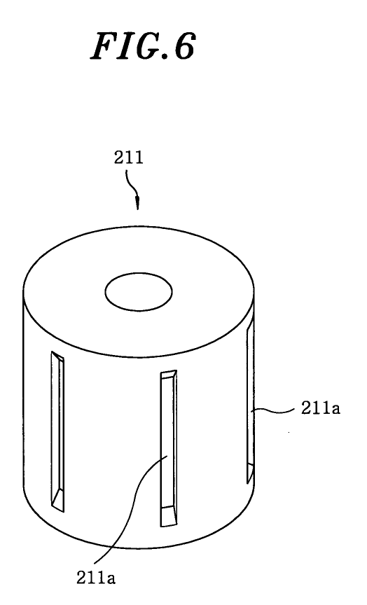

FIG. 5 illustrates a sectional view of a motor 200 in accordance with a second embodiment of the present invention. As similar to the first embodiment of the present invention, it is exemplified in the second embodiment that a rotor 210 is installed in the motor 200, more particularly, the induction motor. The rotor 210 includes a main body 211 and cooling blades 212, and is molded by pressing soft magnetic powder. The main body 211 is installed to be rotatable by having a gap inside a stator 230 affixed to a casing 140, and provides flow paths of magnetic fluxes. The main body 211 includes attachment reinforcing openings 211a on certain outer surface portions of the main body 211. The cooling blades 212 are formed to protrude through injection molding into the respective attachment reinforcing openings 211a of the main body 211. Those parts of the motor 200 different from the motor 100 described in the first embodiment of the present invention will be described in detail.

As illustrated in FIG. 6, the attachment reinforcing openings 211a may be formed as many as the cooling blades 212 and placed on given regions corresponding to the cooling blades 212. In addition, the cooling blades 212 may be formed in an integral structure along the outer surface of the main body 211, or in other various shapes and structures.

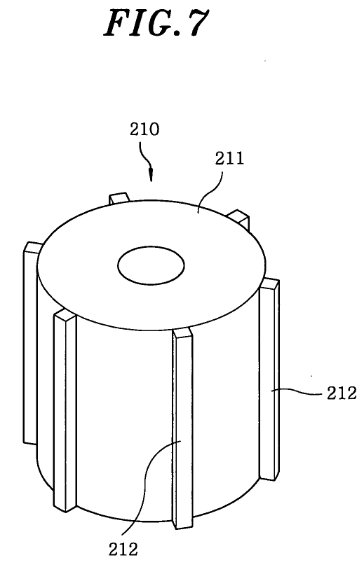

The cooling blades 212 are formed on the given outer surface portions of the main body 211 to run parallel to a shaft 240, which is a central rotation axis. As illustrated in FIG. 7, the cooling blades 212 are formed to protrude through the injection molding into the respective attachment reinforcing openings 211a, and spaced a certain distance apart from each other along the outer surface of the main body 211. As illustrated in the second embodiment of the present invention, the cooling blades 212 may be formed in the shape of a straight line. Instead of this shape, the cooling blades 212 may also be formed in other shapes including curvature.

The rotor 210 having the cooling function operates as follows.

When the rotor 210 rotates by the driving of the motor 200, e.g., the induction motor, the cooling blades 212 also rotates to produce a wind, which causes air to be moved in from the outside of the casing 140 and discharged to the inside thereof. As a result, the inner side of the casing 140 is cooled down.

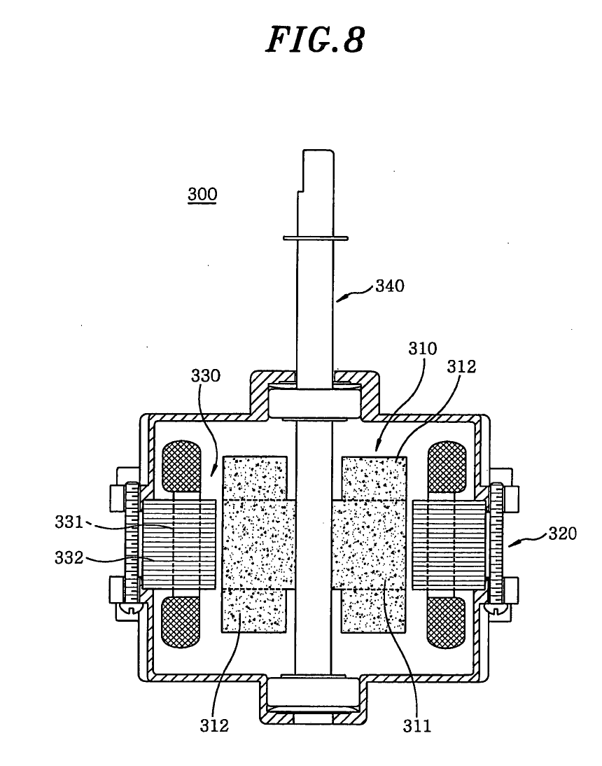

FIG. 8 illustrates a sectional view of a motor 300 in accordance with a third embodiment of the present invention. In the motor 300, a rotor 310 having a cooling function includes a main body 311 and cooling blades 312, and is molded by pressing soft magnetic powder. The main body 311 of the motor 300 is installed to be rotatable by having a gap inside a stator 330, which is affixed to a casing 320, and provides flow paths of magnetic fluxes. A shaft 340 passes through a central region of the main body 311 to be affixed to the main body 311. The cooling blades 312 are formed to be integrated with the main body 311.

As illustrated in FIGS. 8 to 10, a plurality of the cooling blades 312 are arranged individually on both upper and lower surfaces of the main body 311 along the center of rotation, i.e., around the shaft 340. Each of the cooling blades 312 are formed in a half-diameter direction, i.e., toward the outer side from the center of the rotation.

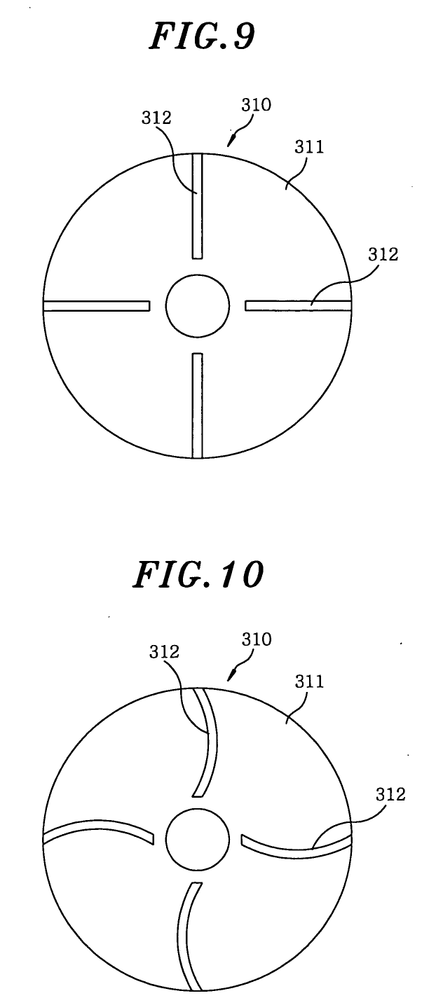

As illustrated in FIG. 9, the cooling blades 312 are formed to be in the shape of a straight line from a top view so as to be easily manufactured. Also, as illustrated in FIG. 10, the cooling blades 312 may be formed in a curved shape, so that the wind can be produced more efficiently.

As described above, the rotor 310 is formed by pressing the soft magnetic powder, and thus, the cooling blades 312 are formed to be integrated with the main body 311. The soft magnetic powder usually includes iron-based particles, each coated with a certain material to be electrically insulated from each other.

For the press molding of the rotor 310, a molding space having substantially the same shape as the rotor 310 is prepared in a press molding machine, and then filled with the soft magnetic powder. Then, a press member such as a punch is used to press the soft magnetic powder to form the cooling blades 312 integrated with the main body 311. At this time, a lubricating agent and/or a binding agent may be added to the soft magnetic powder and pressed together.

The rotor 310 includes a SMC having a three-dimensional shape due to the aforementioned press process on the soft magnetic powder. As compared with the conventional process of using the silicon steel sheets, the rotor 310 is allowed to have an increased degree of freedom. Thus, different from the conventional stack structure of the silicon steel sheets having the same shape, this SMC allows the formation of the cooling blades 312.

Although the implementation of the rotor 310 in the motor 300, more particularly, the induction motor 300, is exemplified in the third embodiment, the rotor 310 can also be implemented in other types of motors such as AC motors and DC motors, which usually require the cooling. In the third embodiment of the present invention, as the rotor 310 is implemented in the induction motor 300, although not illustrated, conductors for providing a certain amount of current to a target are placed around slots formed on the outer surface or the inner side of the main body 311.

The rotor 310 having the cooling function in accordance with the third embodiment of the present invention operates as follows.

When AC current is supplied to a coil 331 of the stator 330, rotating magnetic fluxes are produced through a stator core 132. This rotating magnetic fluxes cross the conductors (not shown) of the rotor 310, placed on the outer surface or the inner side of the main body 311, through the gap to provide a certain amount of current to the conductors (not shown), so that the rotor 310 produces a torque.

Due to the torque, the rotor 310 rotates, and the cooling blades 312 integrated with the main body 311 produces a wind, which causes air to be moved in from the outside of the casing 320 and discharged to the inside thereof. As a result, the inner side of the casing 320 is cooled down.

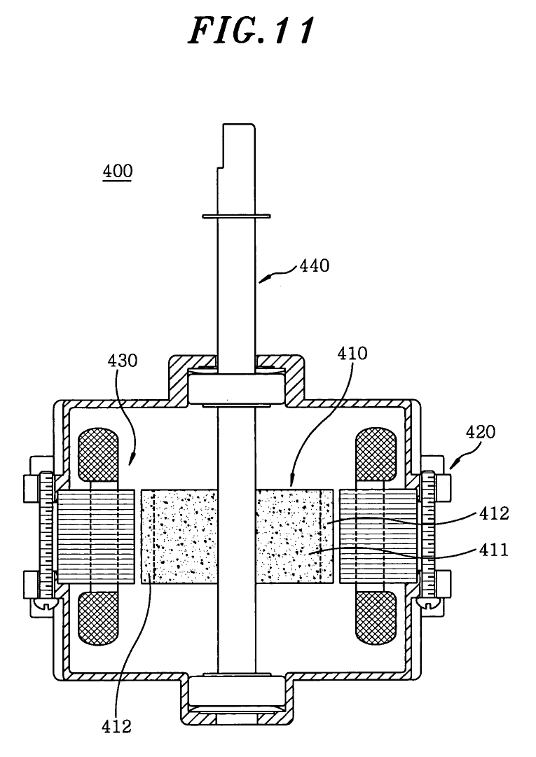

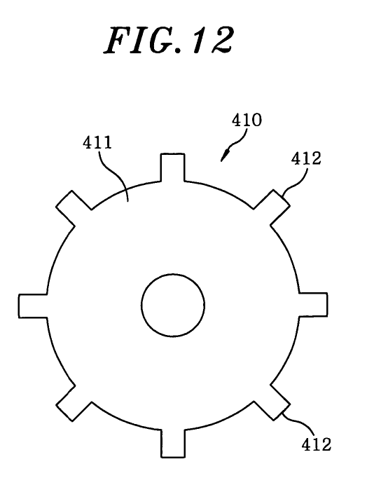

FIG. 11 illustrates a sectional view of a motor in accordance with a fourth embodiment of the present invention. As similar to the above described embodiments, it is exemplified in the fourth embodiment that a rotor 410 is installed in the motor 400, more particularly, the inductor motor. The rotor 410 having a cooling function includes a main body 411 and cooling blades 412, and is molded by pressing soft magnetic powder. The main body 411 of the motor 400 is installed to be rotatable by having a gap inside a stator 430, which is affixed to a casing 420, and provides flow paths of magnetic fluxes. A shaft 440 passes through a central region of the main body 411 to be affixed to the main body 411. The cooling blades 412 are formed to be integrated with the main body 411. Hereinafter, those parts of the rotor 410 different from the rotor 110, 210 or 310 will be described in detail.

In the rotor 410, the cooling blades 412 are formed on given outer surface portions of the main body 411 in parallel to a central rotation axis, i.e., the shaft 440. As substantially the same as the arrangement illustrated in FIG. 12, the cooling blades 412 are arranged a certain distance apart from each other along the outer surface of the main body 411.

As similar to the previous embodiments, the rotor 410 is molded by pressing the soft magnetic powder, and thus, the cooling blades 412 can be formed on the given outer surface portions of the main body 411 in the shape of a straight line or in a curved shape. Since the cooling blades 412 are also formed using the soft magnetic powder, the cooling blades 412 can provide flow paths of the rotating magnetic fluxes produced toward the stator 430. As a result, a certain amount of current can be provided to conductors (not shown), installed on the outer surface or the inner side of the main body 411, and the rotor 410 can also produce a torque.

The rotor 410 of the motor 400 in accordance with the fourth embodiment of the present invention operates as follows.

When the rotor 410 rotates by the driving of the motor, i.e., the inductor motor 400, the cooling blades 412 also rotate to produce a wind, which causes air to be moved in from the outside of the casing 420 and discharge the air to the inside thereof. As a result, the inner side of the casing 420 is cooled down.

On the basis of various embodiments of the present invention, the cooling blades that produce a wind for cooling when the rotor rotates are formed through injection molding. Thus, durability and miniaturization of products can be achieved as well as an assembly process can be simplified. The simplified assembly process contributes to improvement in productivity.

In another embodiment of the present invention, the rotor is manufactured by pressing soft magnetic powder, the cooling blades are additionally prepared to be integrated with the rotor and have a certain structure for bonding to a target. Hence, the motor can be miniaturized, and a manufacturing process can be simplified, thereby improving productivity.

While the invention has been shown and described with respect to the preferred embodiments, it will be understood by those skilled in the art that various changes and modifications may be made without departing from the spirit and scope of the invention as defined in the following claims.

What is claimed is:

1. A rotor for use in a motor with a cooling function, the rotor comprising:
a main body formed by pressing soft magnetic powder; and
a plurality of cooling blades formed to be integrated with the main body to produce a wind for cooling when the rotor rotates.

2. The rotor of claim 1, wherein the main body have a plurality of attachment reinforcing openings, the cooling blades being formed to protrude through injection molding into the respective attachment reinforcing openings of the main body to be integrated with the main body.

3. The rotor of claim 2, wherein the individual attachment reinforcing openings are formed on both upper and lower surfaces of the main body; and the cooling blades are located along a half-diameter direction of the main body and arranged around a central point of rotation of the main body.

4. The rotor of claim 2, wherein the attachment reinforcing openings are formed on given outer surface portions of the main body; and the cooling blades are located in parallel to a central rotation axis of the main body and arranged along the outer surface of the main body.

5. The rotor of claim 2, wherein the cooling blades are made of injection molding material including synthetic resin.

6. The rotor of claim 1, wherein the cooling blades are integrally formed with the main body by pressing the soft magnetic powder along with the main body.

7. The rotor of claim 6, wherein the cooling blades are located on both upper and low surfaces of the main body along a half-diameter direction and arranged around a central point of rotation of the main body.

8. The rotor of claim 6, wherein the cooling blades are located on given outer surface portions of the main body in parallel to a central rotation axis and arranged along the outer surface of the main body.
